(19) United States
(12) Patent Application Publication
(10) Pub. No.: US 2024/0053219 A1
(43) Pub. Date: Feb. 15, 2024

(54) INSPECTION OF TANKS USING LINER AND VACUUM

(71) Applicant: American Tank & Vessel, Inc, Houston, TX (US)

(72) Inventor: William Thomas Cutts, Houston, TX (US)

(21) Appl. No.: 18/232,781

(22) Filed: Aug. 10, 2023

Related U.S. Application Data
(60) Provisional application No. 63/397,774, filed on Aug. 12, 2022.

(51) Int. Cl. G01M 3/24; B65D 90/503; B65D 90/04

(52) U.S. Cl. CPC G01M 3/24; B65D 90/503; B65D 90/046

(57) ABSTRACT

A method and system for detecting and identifying location of leaks in an above-ground storage tank (AST) bottom or wall is provided. The method employs a temporary liner on top of the tank bottom or at the interior of another tank surface capable of holding a vacuum. The temporary liner is installed on the top (interior) side of the surface, sealing the liner to the shell and any potential penetrations such as columns. A temporary spacer may be employed to help ensure the liner itself does not seal well to the bottom. A vacuum is pulled between the liner and the tank surface. After the vacuum is pulled, a portable acoustic device is utilized to target noise generated by air entering the vacuum evident of a gas or liquid leak.

### CROSS-REFERENCE TO RELATED APPLICATIONS

This application claims the benefit, under 35 U.S.C. § 119(e), of U.S. Provisional Patent Application No. 63/397,774 filed Aug. 12, 2022, and entitled “Inspection of Tanks Using Liner and Vacuum”. The entire content of each of this application is incorporated herein by this reference.

### FIELD OF THE INVENTION

The present invention relates to the detection and local identification of leaks in storage tanks and vessel's membranes predominantly the tank or vessel bottom. Precisely, the invention relates to a method and apparatus for detecting leaks in above ground storage tanks by creating a vacuum across the bottom utilizing sonic or ultrasonic detection to find the noise generated by a leak.

### BACKGROUND OF THE INVENTION

Concerns over liabilities associated with tanks that leak and loss of product has resulted in a consistent commitment from governments and industry to ensure our tank bottoms, which are obscured from view are performing There are many concerns because the components stored in tanks can be carcinogenic, harmful to ground water, and/or have other conditions of liability and threat to public health and safety. Codes and standards have been built to address these issues and help with this effort but current standards fall short of effective testing of tank bottoms in many tank installation scenarios.

The liability tied to duration and expense associated with finding leaks in tank bottoms is significant and the industry and the government are demanding that the industry actually generate standards to prevent these actions and minimize contamination of the ground soil and exposure of workers. Existing procedures and equipment for testing are not accurate enough to find small leaks, especially outside the weld areas and/or precise enough to be executed in a reasonable time or at a reasonable cost. Improved methods such as described within this application make it possible to test these tanks more effectively and faster helping to support better integrity associated with our tank bottoms.

The difficulties and issues associated with the process are many. First, tanks are very large in diameter and the leaks referred to can be quite small, such as a 1/16″ diameter in a bottom that may be 200′ in diameter. A 200′ diameter tank has over 4.5 MM sq. in. of area and a total of 1″ sq. of area as a hole would be a significantly sized leak. Ten holes making up less than ½ ″ sq. area on a tank bottom would still be a significant failure condition. Therefore, the challenge is great to ensure that these tank bottoms have full integrity and no holes.

The difficulty of identifying holes in tank bottoms and other tank membranes is also exacerbated by the fact that the materials used often corrode from the top or bottom side. This corrosion can be concentrated and instead of just thinning the whole membrane down it can focus on areas and rust through. Therefore, repairs and scheduled checks and inspections on tank bottoms also have to be executed to ensure that they retain their integrity.

The industry has attempted to find solutions and made some progress associated with detecting and locating leaks in aboveground storage tanks (AST's). There are a variety of known processes to inspect for AST bottom leaks, but none support the simplicity, combined with effectiveness of the present invention. Therefore, the principal object of this invention is to provide a method that is approved above others that supports fast inspection schedule, economic footprint, and accuracy to determine leak locations in AST's and support the ability to test after repair.

### SUMMARY OF THE INVENTION

In one aspect, the present invention is embodied as a leak detection process which relies on a temporary barrier that is utilized to support pulling a vacuum on the topside of the tank bottom and/or tank membrane. The process may employ ultrasonic testing equipment based on a cone for a macro area observation and a wand for micro area observation. Between the temporary liner and the tank bottom or membrane there is a spacer or grid which helps create a cavity between the temporary liner and the tank bottom. This cavity is then hooked up to a vacuum pump which will pump down the cavity to a vacuum pressure, typically between −1 psi and −14.7 psi (one atmosphere). Other vacuum valves can be used to ensure identifying integrity for large leaks versus small leaks.

In some embodiments, after the vacuum is pulled the portable acoustic equipment is utilized in the macro mode using a parabolic reflector such as a cone to cover a wide area and the bottom is walked in a grid fashion ensuring that the whole bottom is looked at with minimal background noise associated with the equipment. A test is performed to ensure that the settings are appropriate on the equipment helping to calibrate it for accuracy and performance associated with each test.

In some embodiments, after ultrasonic background noise appears to detect a leak, the cone is replaced with a wand attachment, which can be utilized to touch the outer liner to help target in specifically to a potential leak area. After identifying the leak location, a small section of the temporary liner will be cut out and removed to expose the tank surface and locate the potential leak. The potential leak may be examined with other NDE type techniques, and then repairs executed. Once repair and testing has been executed the temporary liner is patched and vacuum reinstated, and the area checked again. This process continues whereby each leak can be repaired and tested before continuing or all can be identified first and then repaired returning for a single re-vacuuming of the environment. Caution must be shown because large leaks could obscure smaller leaks in their immediate vicinity. Also, the presence of large leaks means that gas is moving through the temporary gas membrane area set up by the grid under the liner and this can cause for false indications also. Therefore, any large leaks need to be identified and repaired before the process is completed.

In another aspect, the present invention is embodied as a system or kit containing the equipment and supplies for performing the method, or portions thereof. Various other aspects and embodiments may be found in the disclosure below.

### BRIEF DESCRIPTION OF THE DRAWINGS

FIG. 1 is a cross sectional view of an AST showing a tank shell 1, the tank foundation 2 and the tank bottom 3.

FIG. 2 is a detail cross-sectional drawing showing the temporary liner system 4 laying on the tank bottom 3 sealed to the tank shell 1 by a temporary seal 6 that is attached to the shell 1 and also attached to the liner 4. The same drawing depicts a column 7 with a similar sealing system used to seal the temporary line 4 to the shell 1.

FIG. 3 is a detailed drawing of an example of a pipe 8 attached to the temporary liner 4 with a gauge 9 and hose 10 that runs to a source that can create a vacuum on the environment.

FIG. 4 is an example of a portable ultrasonic gun or device 11 available in the marketplace that can be aimed at different areas to pick up ultrasonic waves and analyze them into sound or readings to help the operator to identify a leak source.

FIG. 5 represents the spacer material that is temporarily and placed on top of the tank bottom 3 under the temporary liner 4. The spacer material HDPE 14, spacer material sand 15 or spacer material wire 16 could be used interchangeably and/or together or with other materials to provide a small gap between the tank bottom 3 and the temporary liner 4.

### DETAILED DESCRIPTION OF THE PREFERRED EMBODIMENTS

A method for detecting and identifying location of a leak or plural leaks in an above-ground storage tank (AST) bottom and/or other tank walls that could be treated in a similar fashion with this equipment. The method employs a temporary liner, positioned near of the tank bottom or other surface, capable of holding a vacuum combined with portable acoustics equipment to sense the acoustic generated by air and/or potentially liquid migrating through a small opening. The temporary liner is installed on the top side of the bottom, sealing it to the shell and any potential penetrations such as columns. Before the liner is put down, a temporary spacer such as a mesh type system provide some vapor space helping to ensure the liner itself does not seal well to the bottom is installed temporarily also. After installation of this temporary liner, a vacuum is pulled between the liner and the top side of the tank bottom creating a vacuum differential between the upper side of the bottom and the lower side. After the vacuum is pulled, a portable acoustic device is utilized to target noise generated by air entering the vacuum evident of a gas or liquid leak. The locations are identified with a wand attachment to the ultrasonic testing equipment and marked. Once identified the vacuum is released and the temporary liner is removed in that immediate region then localized vacuum or other tests such as a leak penetrant etc. can be used to confirm the leak. Once repairs are made, then the temporary liner that has been removed from that immediate region is repaired and the process is started again to ensure that the leak has been repaired and that are no other leaks. Once these tests are completed no other leaks are found the temporary liner is totally removed from the tank and the tank is ready for service.

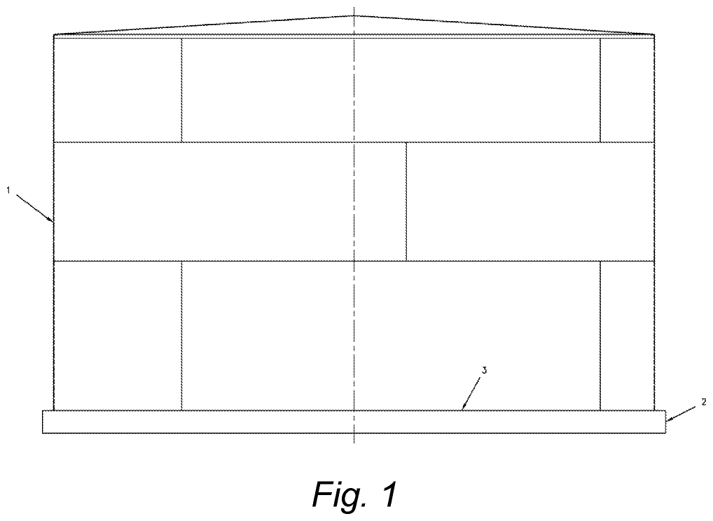

Referring to FIG. 1 there is a depiction of an elevation view of a standard AST above-ground liquid storage tank 1. The storage tank 1 is constructed traditionally out of steel to hold liquid and sometimes solid contents and supported on a foundation 2 that can be manufactured out of aggregate, concrete, or wood, for example. The depiction also shows the tank bottom 3 on top of the foundation 2.

The tank 1 shown in FIG. 1 can be supported on different aggregates such as sand and concrete in such a manner that it is relatively uniform to the stresses the tank presents on the foundation. Therefore, foundations 2 for tanks 1 can be made of a variety of materials and be solid or loose, a hybrid, or even different materials based on the perimeter and the interior areas of the tank bottom 3.

As shown in FIG. 1 the tank bottom 3 is supported and rests on the foundation 2 in a relatively uniform manner, but this relationship means that the gap between the bottom 3 and foundation 2 is typically minimal or nothing at all.

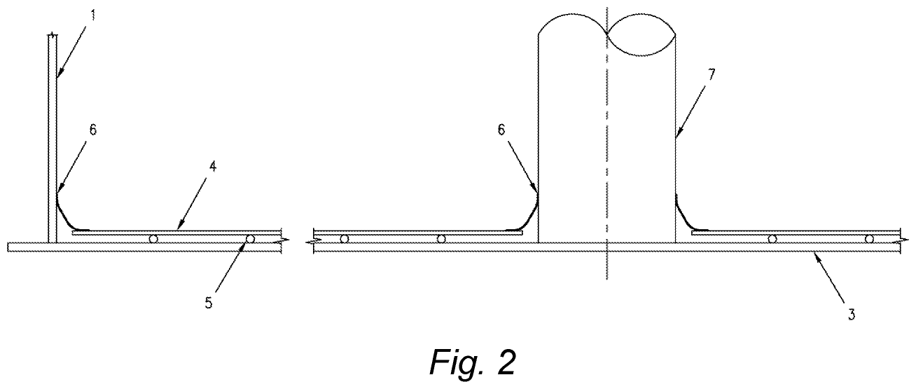

As shown in FIG. 2 a temporary liner 4 has been added to the bottom of tank 1 for inspection purposes and is supported with a liner substructure such as the depicted temporary spacer 5 and temporarily sealed at the wall with a seal 6 to establish a complete membrane temporarily over the tank bottom. Temporary liner 4 is positioned near the surface to be measured, close enough to ensure a relatively small time, i.e. minutes and not hours, is needed to produce a suitable vacuum pressure with a portable pump able to be carried into the tank, but far enough away to prevent the liner from deforming against the surface in the area to be measured bounded by the seal while the vacuum is applied, with the liner edges sealed against the surface. For example, this distance is typically less than a few inches are preferably less than an inch, more preferably less than ½ inch. FIG. 2 also depicts a tank column 7, to support a cone roof or for other purposes, that is permanently part of the tank 1. For example, column 7 can support an exterior roof or enable other functions such as product sampling, product removal, or bottom filling Such columns, and other structures arising from the tank bottom 4, when present, require the temporary liner 4 to be sealed to the column with a liner seal 6. All components that arise from the tank bottom, such as columns will need to be sealed in some fashion with the perimeter seal 6 system for the temporary liner 4 to be leak proof.

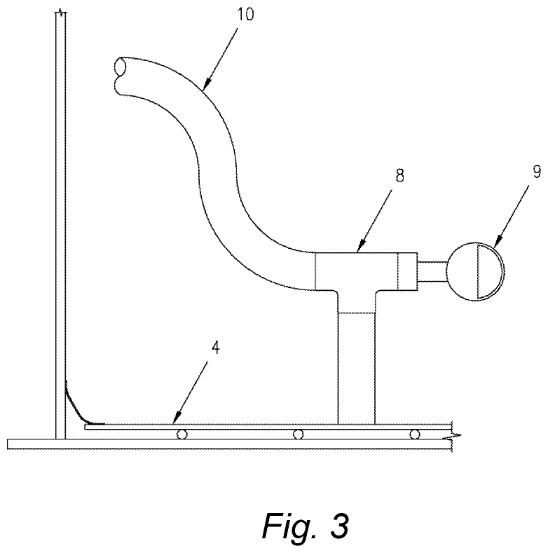

As shown in FIG. 3 the temporary liner 4 is fitted with a nozzle 8 connection to an opening in temporary liner 4. Nozzle 8 is connected to a gauge 9 for vacuum indication and piping 10 to a vacuum source. The connection of temporary liner 4 with a vacuum source through nozzle 8 provides the ability to pull a vacuum through temporary liner 4 on the volume of a temporary volume bounded by the temporary liner 4, the tank bottom 3, temporary seal 6, and other structures such as columns. Pulling such a vacuum on the temporary liner 4 will create air flow between the outside atmosphere and the cavity through nozzle 8 temporary liner if there is a hole in the tank bottom 3. Sonic or ultrasonic detection is used to locate holes as further described below. Any holes in the temporary liner 4 are repaired.

Generally, temporary liner 4 may be made of a variety of materials suitable for forming an airtight liner. The material may be rigid or flexible in various embodiments, but should have sufficient rigidity that it does not deform against the tank bottom 3 in the presence of temporary spacer 5. For example, temporary liner 4 may be constructed of one more plastic sheets (such as 3/16″ PTFE sheeting), metal sheets, or composite material. As another example, an airtight coated fabric may be used, such as nylon with a coating of latex, urethane, or a thermoplastic polyurethane (TPU), for example. Temporary liner 4 may include multiple pieces assembled in place on the tank bottom 3 and sealed together. Such pieces may be provided as part of an inspection kit, pre-cut to fit the size of the particular tank bottom being inspected. Generally, it is expected that inspection personnel will walk on temporary liner 4 for tank bottom inspections, therefore temporary liner 4 and temporary spacer 5 should be durable enough in combination to allow such mobility. In some embodiments, a re-usable temporary liner 4 and temporary spacer 5, sized to cover a target tank bottom plan, is provided suitable for performing multiple inspections.

Temporary seal 6 may be formed of any suitable material for providing an airtight seal between temporary liner 4 and the tank surface. For example, sealing foam may be used. A sealing tape may also be used. Various sealing materials may also be combined.

In a preferred method, temporary liner 4 covers the entire surface of tank bottom 3, allowing for complete inspection of tank bottom 3 for leaks. In other embodiments, only a portion of the surface is covered by temporary liner 4, and the seal 6 is sealed against the surface itself. In some embodiments, a similar process may be employed to inspect other surfaces of tank 1 such as the walls, which are also difficult to inspect for leaks in many installations. In such a process, a temporary spacer 5 and temporary liner 4 may be positioned over the entire tank wall, or a selected portion of the wall. The liner may be positioned inside or outside the tank. Such temporary liner may be suspended at its top end, and sealed against the floor at the bottom end. The vacuum inspection process described herein is then employed to inspect the tank wall for leaks.

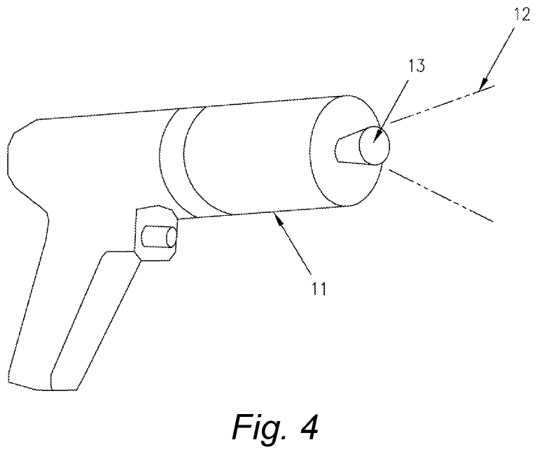

FIG. 4 depicts an ultrasonic amplifier 11 or acoustic detector for use with the system or method herein. While ultrasound frequencies are detected in this example, in some embodiments of a method or system, audible sound frequencies may be used, alone or in combination with ultrasound frequencies. Ultrasonic amplifier 11 includes an ultrasonic microphone and associated electronics for amplifying ultrasonic frequencies and an indicator or other output for displaying or communicating the acoustic noise level detected. Preferably, ultrasonic amplifier 11 also includes frequency translation electronics for translating audio signals detected in the ultrasonic frequency range to within the human audible range (as typically defined). Such circuitry is commercially available in the industry and will not be further described herein. The translated signals are fed to an external speaker or headphones, by which trained operators can identify sounds associated with leaks. The ultrasonic amplifier is fitted with a parabolic reflector such as the depicted cone 12 for picking up noise in a large range. This cone 12 can be changed out to a more directionally precise component such as a wand (interference tube) or other highly directional microphone attachment for higher accuracy in identifying the location to acoustic emissions. Once a vacuum has been created under the temporary liner 4 and above the tank bottom 3, the acoustic amplifier 11 is utilized to find leaks in either the temporary liner and/or the tank bottom. Once a leak has been found in a region the acoustic equipment can be altered or utilized in a different way to help identify a specific location. If the leak is found in the temporary liner 4 it will be well repaired before proceeding with the test. Once all leaks in the temporary liner 4 have been sealed, trained personnel and/or robotic equipment or even fixed equipment can scan the temporary liner 4 looking for sound indicating a leak in the tank bottom 3. Once a more precise location of the acoustic sound and/or a leak is identified, the temporary liner 4 has a portion removed and further investigation of the tank bottom 3 is performed to identify the specific leak and repair procedure. Once the repair has been accomplished, the liner can be repaired and the process started again to ensure no leaks exist in the tank bottom 3.

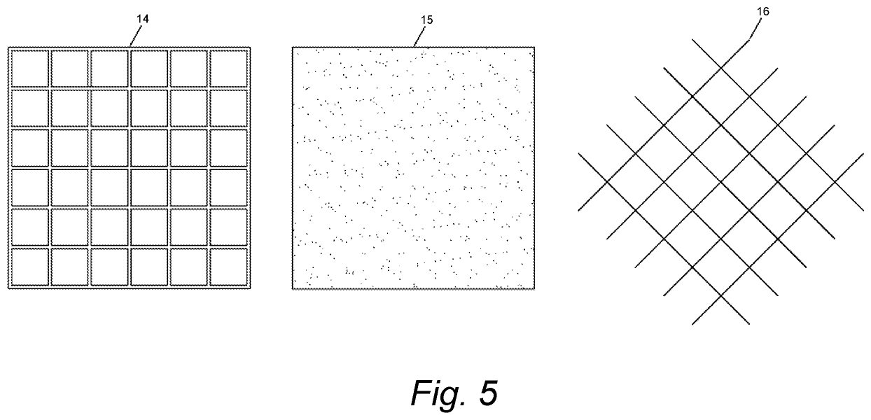

Individuals skilled in the art of detecting leaks in above ground storage tank bottoms and membranes will appreciate this new technique and its new and useful ability to help determine leaks in tank bottoms. In particular, they will recognize the advantages of a technique that is able to meet inspection standards while it supports fast inspection schedule, economic footprint, and accuracy to determine leak locations in AST's and support the ability to test after repair. While the present description sets forth preferred embodiments of the present invention, it will be apparent that a variety of modifications may be made therein without departing from the true scope and spirit of the present invention, which the claims appended here to are intended to cover. For example, FIG. 5 depicts the different types of layouts and materials that could be utilized for the temporary liner 4 temporary spacer 5 system in some alternative embodiments. Multiple layers of material may be used, as well as differing sizes, materials made of steel, aluminum, plastic, HDPE, and/or even sand could act as the temporary spacer 5 material. Even plastic grading or other materials could certainly perform, as well as no spacer material 5 whatsoever is required for the system to work.

In FIG. 5, a plan view is shown of temporary spacer material high density polyethylene (HDPE) 14, temporary spacer material sand 15 and temporary spacer material steel 16, which are all depicted as basic examples of different types of materials that can be utilized between the tank bottom 3 and the temporary liner 4 to present a small air gap suitable for forming a vacuum and detecting leaks as described above. Generally, the temporary spacer material is selected to have sufficient thickness to prevent temporary liner 4 from deforming against the tank bottom or other surface when placed under vacuum. The temporary spacer 14 supports the temporary liner 4 around the edges and also centrally over the surface for which leak detection is performed, preventing deformation against the surface. Temporary spacer 15 provides support and spacing with sand, and generally supports the entire temporary liner 4 enough to prevent deformation against the tank surface. The seal may provide some support along the edges such as tank walls and columns. Sand or other particles or pellets are spread with a sufficient density to prevent deformation against the tank surface, with the density depending on the size of particles and the flexibility of the temporary membrane. Referring to temporary spacer material 14 and 16, the particular size and spacing of the grid pieces are selected to prevent deformation against the tank surface. The particular selection of material and size made will vary depending on several factors such the rigidity of temporary liner 4, the area coverage of the spacer material (particularly the size of gaps in the spacer material), and the strength of the vacuum used. Pellets or other pieces of material may be distributed along tank bottom 3 to form a layer of spacer material. While a grid or grating of HDPE 14 or metal 16 are shown, other materials such as fiberglass may also be used to form such a grid.

While a separate temporary liner and temporary spacer material are shown herein, in other embodiments the spacer material may be joined with the temporary liners. For example, temporary liner 4 may be constructed of one more plastic sheets (such as PTFE) including ridges, bumps, or other spacer structures along one surface to provide the temporary spacer material.

Thus, various embodiments of a leak detection process have been described. The invention may also be embodied as a system for performing the process according to its various possible implementations. For example, a system including a temporary liner for fitting along a tank bottom, a temporary spacer for fitting along a tank bottom, and a vacuum port formed in the liner is provided.

Further, as described herein, the various features have been provided in the context of various described embodiments, but may be used in other embodiments. The combinations of features described herein should not be interpreted to be limiting, and the features herein may be used in any working combination or sub-combination according to the invention. This description should therefore be interpreted as providing written support, under U.S. patent law and any relevant foreign patent laws, for any working combination or some sub-combination of the features herein.

The above-described embodiments are intended to illustrate the principles of the invention, but not to limit the scope of the invention. Various other embodiments and modifications to these example embodiments may be made by those skilled in the art without departing from the scope of the present invention.

1. A method of inspecting a tank comprising:
positioning a temporary liner inside the tank near a surface of the tank interior;
sealing edges of the temporary liner against walls of the tank to create a volume between the temporary liner and the surface;
pumping a vacuum through an opening in the temporary liner; and
after pumping the vacuum, detecting acoustic noise to locate leaks in the surface.

2. The method of claim 1, further comprising:
positioning a spacer material inside the tank along the surface, and wherein positioning the temporary liner near the surface includes positioning the temporary liner against the spacer material.

3. The method of claim 2 wherein:
the temporary liner at least partially comprises a flexible material, and wherein the spacer material has a thickness sufficient to prevent the temporary liner from deforming against the surface.

4. The method of claim 2 wherein:
the spacer material comprises a grid.

5. The method of claim 2 wherein:
the spacer material comprises sand.

6. The method of claim 1 wherein:
the temporary liner comprises PTFE.

7. The method of claim 1 wherein:
detecting acoustic noise further comprises using a directional ultrasonic microphone positioned outside of the volume.

8. The method of claim 7 wherein:
the surface is a bottom surface of tank interior.

9. The method of claim 1 wherein sealing the edges of the temporary liner includes applying an airtight spray foam along the edges and allowing the foam to dry.

10. The method of claim 1, further comprising:
after detecting a leak, cutting an opening in the temporary liner at a location of leak;
repairing the leak;
repairing the opening in the temporary liner; and
pulling the vacuum again verifying the leak is repaired by detecting the absence of leak sounds at a location of the leak.

11. A system for inspecting a tank comprising:
a temporary liner sized for positioning inside the tank near a surface of the tank interior and including an opening with a nozzle;
a seal or a sealing material, for sealing edges of the temporary liner against walls of the tank to create a volume between the temporary liner and the surface;
a pump for pumping a vacuum through an opening in the temporary liner; and
an acoustic detector for detecting acoustic noise to locate leaks in the surface.

12. The system of claim 11 further comprising:
a spacer material for separating the temporary liner from the surface.

13. The system of claim 12 wherein:
the temporary liner at least partially comprises a flexible material, and the spacer material has a thickness sufficient to prevent the temporary liner from deforming against the surface.

14. The system of claim 12 wherein:
the spacer material comprises a grid.

15. The system of claim 12 wherein:
the spacer material comprises sand.

16. The system of claim 11 wherein:
the temporary liner comprises PTFE.

17. The system of claim 11 wherein:
the acoustic detector includes frequency translation electronics for translating audio signals detected in the ultrasonic frequency range to within the human audible range.
